(19) United States
(12) Patent Application Publication
(10) Pub. No.: US 2025/0307389 A1
(43) Pub. Date: Oct. 2, 2025

(54) LOG ANALYSIS DEVICE, LOG ANALYSIS METHOD, AND STORAGE MEDIUM THEREOF

(71) Applicant: DENSO CORPORATION, Kariya-city (JP)

(72) Inventors: Keigo NAGARA, Kariya-city (JP); Taiji ABE, Kariya-city (JP); Naoya ISHIDA, Kariya-city (JP); Keita HAYAKAWA, Kariya-city (JP); Masumi EGAWA, Kariya-city (JP); Tomonori IKUSE, Kariya-city (JP)

(21) Appl. No.: 19/082,250

(22) Filed: Mar. 18, 2025

(30) Foreign Application Priority Data
Mar. 28, 2024 (JP) 2024-054887

(51) Int. Cl. G06F 21/55

(52) U.S. Cl. CPC G06F 21/554; G06F 2221/034

(57) ABSTRACT

A log analysis device includes a storage unit in which false positive confirmation rules and false positive estimation rules are stored. The log analysis device is configured to: acquire a security event log indicating an abnormality detected by a security sensor of an electronic control device mounted on a vehicle; acquire vehicle state information indicating an internal state or an external state of the vehicle; determine whether the security event logs is a confirmed false positive log using the false positive confirmation rule or an estimated false positive log using the false positive estimation rule; and output the estimated false positive log together with flag information with the confirmed false positive log being not output.

### CROSS REFERENCE TO RELATED APPLICATION

The present application claims the benefit of priority from Japanese Patent Application No. 2024-054887 filed on Mar. 28, 2024. The entire disclosure of the above application is incorporated herein by reference.

### TECHNICAL FIELD

The present disclosure relates to a log analysis device that analyzes security event logs output when an attack occurs against an electronic control system installed in a mobile object, such as an automobile.

### BACKGROUND

In recent years, driving assistance technology and automated driving control technology, such as vehicle-to-vehicle communication and roadside-to-vehicle communication, which are known as vehicle to everything (V2X), have been attracting attention. As a result, vehicles are equipped with communication function, and connectivity of the vehicle is progressing. Since the vehicles are equipped with communication function, the vehicles may receive cyberattacks, and unauthorized access to the vehicles may increase. Therefore, it is necessary to analyze the cyberattack on vehicles and to construct countermeasures against the cyberattack.

### SUMMARY

A log analysis device includes a storage unit storing a false positive confirmation rule and a false positive estimation rule. The false positive confirmation rule is used to determine whether an abnormality indicated by a security event log is a false positive abnormality that is not caused by a cyberattack, and the false positive estimation rule is used to determine whether the abnormality indicated by the security event log has a possibility of the false positive abnormality. The log analysis device, by executing a program stored in a non-transitory tangible storage medium using at least one processor, is configured to: acquire one or more security event logs indicating abnormalities detected by a security sensor of an electronic control device mounted on a vehicle; acquire vehicle state information indicating an internal state or an external state of the vehicle; based on the one or more security event logs or the vehicle state information, determine whether each of the one or more security event logs is a confirmed false positive log, which is confirmed as a false positive log, using the false positive confirmation rule and determine whether each of the one or more security event logs is an estimated false positive log, which has a possibility of false positive log, using the false positive estimation rule; and output the estimated false positive log together with flag information, which indicates that the security event log being determined as the estimated false positive log, with the confirmed false positive log being not output.

### BRIEF DESCRIPTION OF DRAWINGS

Objects, features and advantages of the present disclosure will become apparent from the following detailed description made with reference to the accompanying drawings. In the drawings:

FIG. 1 is an explanatory diagram for explaining an arrangement of a log analysis device according a first embodiment of the present disclosure;

FIG. 2 is an explanatory diagram for explaining an arrangement of a log analysis device according a second embodiment of the present disclosure;

FIG. 3 is an explanatory diagram for explaining an arrangement of a log analysis device according a third embodiment of the present disclosure;

FIG. 4 is a block diagram illustrating a configuration example of an electronic control system according to each embodiment of the present disclosure;

FIG. 5 is an explanatory diagram for explaining a security event log output from a security sensor of the electronic control system of each embodiment;

FIG. 6 is a block diagram for explaining a configuration example of a log analysis device according to each embodiment;

FIG. 7 is an explanatory diagram for explaining a false positive confirmation rule used in each embodiment;

FIG. 8 is an explanatory diagram for explaining a false positive estimation rule used in each embodiment;

FIG. 9 is an explanatory diagram for explaining the false positive confirmation rule and the false positive estimation rule used in each embodiment; and

FIG. 10 is a flowchart for explaining an operation of the log analysis device of each embodiment.

### DETAILED DESCRIPTION

There are various technologies for detecting abnormalities occurred in vehicles and analyzing cyberattacks based on the detected abnormalities. For example, according to a related art, an attack path analysis unit of a center device analyzes the received abnormality log to estimate an attack path of the attack on a vehicle. The abnormality log is generated by a security sensor of each ECU and then sent to the center device.

The inventors of the present disclosure have found the following difficulties. If security event logs, which indicate abnormalities detected by security sensors of electronic control units installed in a vehicle, include a false positive security event log, which indicates an abnormality not caused by a cyberattack, an estimation accuracy of attacks, attack paths or the like, for which the security event logs are analyzed, may decrease.

Therefore, whether the security event log is false positive log needs to be determined first, and then the security event log determined as the false positive log is should be excluded from the log analysis target. However, it is not easy to determine whether a security event is false positive or not, and if an important security event log is incorrectly determined as false positive due to an incorrect determination and is excluded from the log analysis, this will result in a decrease in the analysis accuracy of cyberattacks and attack paths.

According to an aspect of the present disclosure, a log analysis device includes a storage unit storing a false positive confirmation rule and a false positive estimation rule. The false positive confirmation rule is used to determine whether an abnormality indicated by a security event log is a false positive abnormality that is not caused by a cyberattack, and the false positive estimation rule is used to determine whether the abnormality indicated by the security event log has a possibility of the false positive abnormality. The log analysis device, by executing a program stored in a non-transitory tangible storage medium using at least one processor, is configured to: acquire one or more security event logs indicating abnormalities detected by a security sensor of an electronic control device mounted on a vehicle; acquire vehicle state information indicating an internal state or an external state of the vehicle; based on the one or more security event logs or the vehicle state information, determine whether each of the one or more security event logs is a confirmed false positive log, which is confirmed as a false positive log, using the false positive confirmation rule and determine whether each of the one or more security event logs is an estimated false positive log, which has a possibility of false positive log, using the false positive estimation rule; and output the estimated false positive log together with flag information, which indicates that the security event log being determined as the estimated false positive log, with the confirmed false positive log being not output.

With the above-described configuration, the log analysis device can improve a determination accuracy of false positive log. As a result, the log analysis device can improve an analysis accuracy of cyberattack using the security event logs in analysis performed by a security operations center (SOC).

The following will describe embodiments of the present disclosure with reference to the accompanying drawings.

In the present disclosure, the effects described in embodiments may be effects obtained by a configuration of an exemplary embodiment of the present disclosure, and may not be necessarily effects of the present disclosure.

When multiple embodiments (including modifications) are described, the present disclosure is not limited to configurations described in the multiple embodiments, and can be properly combined across the embodiments. For example, the configuration disclosed in one embodiment may be combined with another embodiment. The disclosed configurations in respective embodiments may be partially combined with one another.

The difficulty described above is not a publicly known difficulty but is originally found by the inventors of the present disclosure, and is a fact that confirms non-obviousness of the present application together with a configuration and a method described in the present disclosure.

### 1. Configuration Common to All Embodiments

### (1) Arrangement of Log Analysis Device

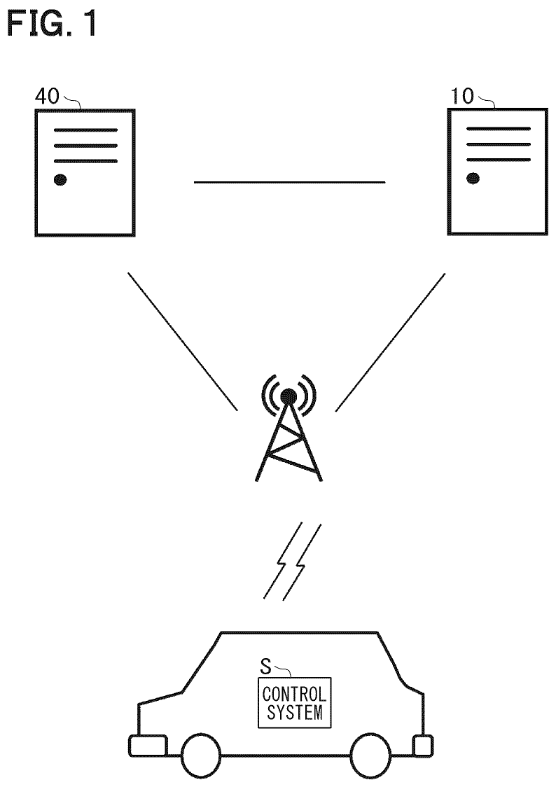

With reference to FIG. 1 to FIG. 3, an arrangement of a log analysis devices according to each embodiment will be described.

FIG. 1 shows a log analysis device 10 according to a first embodiment. The log analysis device 10 is arranged outside a vehicle and is connected to an electronic control system S mounted on the vehicle. The log analysis device 10 is provided by, for example, a security operations center (SOC) or another server device.

The term “vehicle” refers to a movable object, and may have a travel speed of any value. In addition, a case in which the vehicle is stopped is also included in a scope of the vehicle. Examples of vehicle include, but are not limited to, automobiles, motorcycles, and bicycles.

The electronic control system S includes an electronic control device, which is referred to as ECU (electronic control unit). The log analysis device 10 and the electronic control system S are connected via a communication network using a wireless communication method, such as IEEE802.11 (Wi-Fi (registered trademark)), IEEE802.16 (WiMAX (registered trademark)), W-CDMA (Wideband Code Division Multiple Access), HSPA (High Speed Packet Access), LTE (Long Term Evolution), LTE-A (Long Term Evolution Advanced), 4G, 5G, etc. Alternatively, dedicated short range communication (DSRC) may be used in the communication between the log analysis device and the electronic control system. When the vehicle is parked in a parking lot or housed in a repair shop, a wired communication may be used instead of the wireless communication. For example, a LAN (Local Area Network) such as Ethernet (registered trademark), the Internet, an optical line, or a fixed telephone line may be used.

In addition, a communication line combining the wireless communication method and the wired communication method may be used for the communication between the log analysis device and the electronic control system. For example, the electronic control system S and a base station device in a cellular system may be connected by a wireless communication method, such as 4G. The base station device and the log analysis device 31 may be connected by a wired communication method, such as a communication line of a telecommunications carrier or the Internet. A gateway device may be provided at a point of contact between the communication line of the telecommunications carrier and the Internet.

An external device 40 is provided outside the vehicle, similar to the log analysis device 31, and is implemented by, for example, a server device. The external device 40 mainly provides various types of information to the log analysis device 10.

The external device 40 and the log analysis device 31 may be connected by a wired communication method.

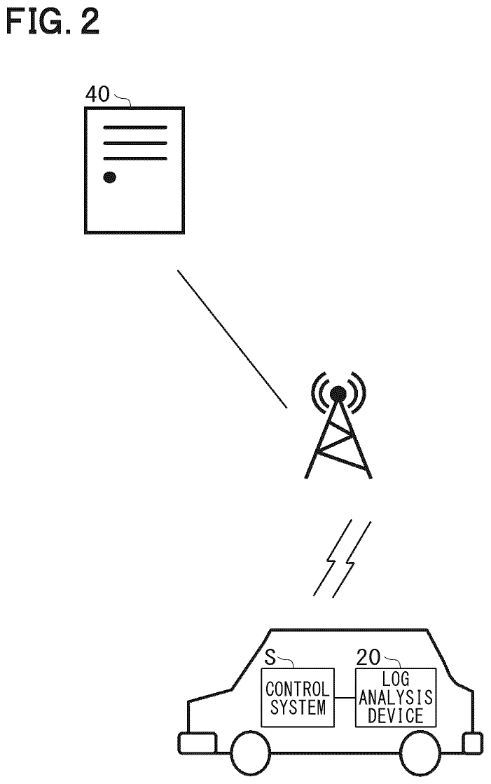

FIG. 2 shows a log analysis device 20 according to a second embodiment. Unlike the first embodiment, the log analysis device 20 is mounted on a vehicle and is connected to the electronic control system S, which is also mounted on the vehicle.

Here, the term “mounted” includes not only a case where the device is directly fixed to the vehicle, but also a case where the device is not fixed to the vehicle but moves together with the vehicle. Examples of term “mounted” include a case where the device is carried by a person in the vehicle, and a case where the device is attached to a load placed in the vehicle.

The log analysis device 20 is connected to the electronic control system S or an ECU of the electronic control system S via an in-vehicle communication network, such as a Controller Area Network (CAN) or a Local Interconnect Network (LIN). Alternatively, the connection may adopt any wired or wireless communication method, such as Ethernet (registered trademark), Wi-Fi (registered trademark), or Bluetooth (registered trademark).

In FIG. 2, the log analysis device 20 is arranged outside the electronic control system S, but the log analysis device 20 may be arranged inside the electronic control system S, that is, as a part of the electronic control system S.

In addition, the connection refers to a state in which data can be exchanged, and includes virtual connections between virtual machines implemented on the same hardware as well as a case in which different hardware circuits are connected via wired or wireless communication network.

The external device 40 and the log analysis device 20 are connected by a wireless communication method or a wired communication method. Examples of the wired communication method and the wireless communication method have already been described in the description of FIG. 1.

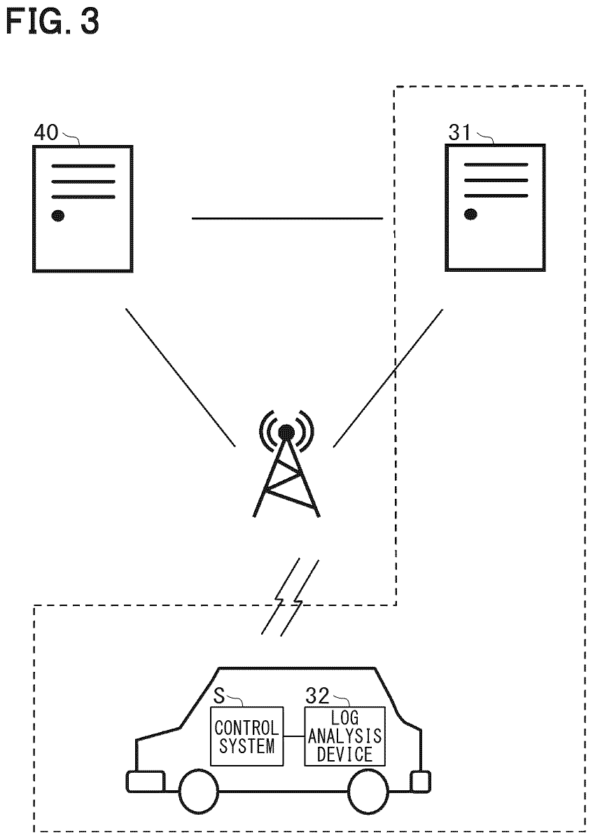

FIG. 3 shows a log analysis device 31 and a log analysis device 32 according to a third embodiment. The log analysis device 31 and the log analysis device 32 are configured such that the functions of the outside log analysis device 10 of the first embodiment and the functions of the inside log analysis device 20 of the second embodiment are combined. Of course, the log analysis device 31 and the log analysis device 32 may have the same functions.

It should be noted that the log analysis device 31 and the log analysis device 32 each corresponds to a log analysis device, and the log analysis device 31 and the log analysis device 32 together correspond to one log analysis device.

For other features of the log analysis device 31, the description of the log analysis device 10 of the first embodiment needs to be referred to, and for other features of the log analysis device 32, the description of the log analysis device 20 of the second embodiment needs to be referred to.

The arrangement of the log analysis device according to each embodiment has been described above with reference to FIG. 1 to FIG. 3.

Since the log analysis device 20 and the log analysis device 32 are mounted on the vehicle, they are suitable for acquiring internal state information indicating the internal state of the vehicle from the electronic control system S or the like. In addition, since the log analysis device 10 and the log analysis device 31 are provided outside the vehicle, they are suitable for acquiring external state information indicating the external condition of the vehicle from the external device 40 or the like. The internal state information and the external state information constitute vehicle state information.

Alternatively, the log analysis device 10 and the log analysis device 31 may acquire internal state information of the vehicle, or the log analysis device 20 and the log analysis device 32 may acquire external state information of the vehicle.

### (2) Configuration of Electronic Control System

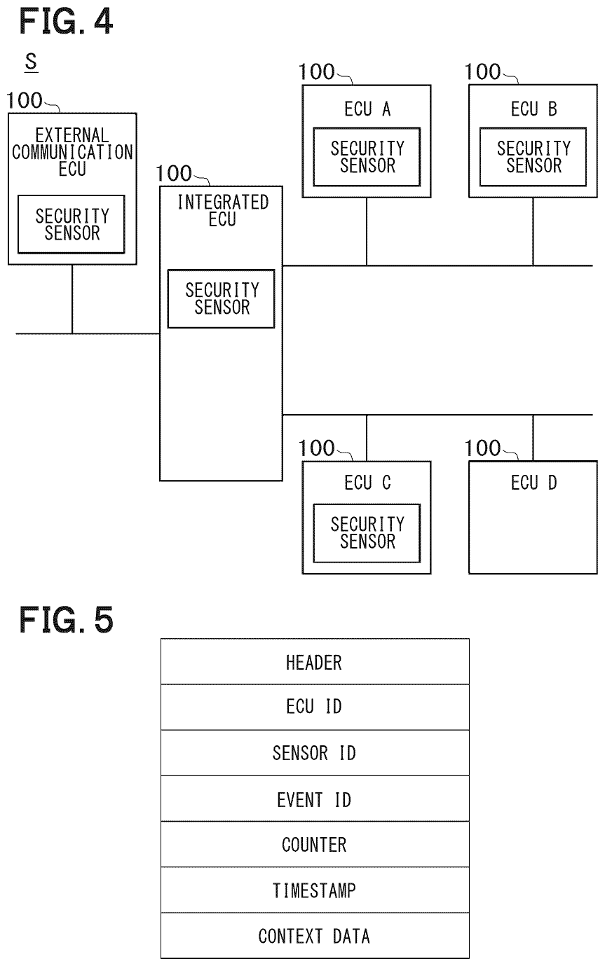

FIG. 4 is a diagram showing a configuration example of the electronic control system S. The electronic control system S includes multiple ECUs 100, such as an external communication ECU and an integrated ECU, which are connected via the in-vehicle communication network. FIG. 4 illustrates one external communication

ECU, one integrated ECU, and four individual ECUs (ECUs A, B, C, and D). The electronic control system S may include any number of ECUs. The term “ECU” is used as a generic term with reference symbol of 100 for the external communication ECU, the integrated ECU, and the individual ECUs.

The external communication ECU communicates with an outside device. The communication method used by the external communication ECU is as described in the above-mentioned wireless communication method and wired communication method. In order to implement above-described multiple communication methods, multiple external communication ECUs may be provided.

The integrated ECU has a gateway function that relays communication between the individual ECUs and the external communication ECU. The integrated ECU may be provided with a function for controlling the entire electronic control system S, for example, a security function. The integrated ECU may be referred to as a gateway ECU (G-ECU) or a mobility computer (MC). Further, the integrated ECU may be a relay device or a gateway device.

The individual ECUs of the electronic control system S may have respective functions. The electronic control unit (ECU) may be a drive system electronic control device that controls an engine, a steering wheel, a brake, etc. The ECU may be a vehicle body electronic control device that controls a meter, a power window, etc. The ECU may be an information system electronic control device, such as a navigation device. The ECU may be a safety control electronic control device that controls the vehicle to prevent a collision with an obstacle or a pedestrian. Further, the ECUs may be classified into masters and slaves instead of being parallel to one another.

The ECU may be a physically independent ECU, or may be a virtual ECU (also referred to as a virtual machine), which is virtually implemented.

In the electronic control system S shown in FIG. 4, each ECU is equipped with a security sensor. Alternatively, partial ECUs may be equipped with respective security sensors.

When the log analysis device 20 or the log analysis device 32 is arranged outside the electronic control system S, the log analysis device 20, 32 or the like may be connected to the electronic control system S shown in FIG. 2 via an in-vehicle communication network or a network using another communication method. When the log analysis device 20 or the log analysis device 32 is included in the electronic control system S, the log analysis device 20, 32 may be arranged in any ECU, such as the integrated ECU.

When the log analysis device 20 or the log analysis device 32 is arranged outside the electronic control system S, the log analysis device 20, 32 may perform communication with a device outside the vehicle, using an independent communication device provided in the log analysis device 20 or the log analysis device 32 or an external communication ECU of the electronic control system S. When the log analysis device 20 or the log analysis device 32 is provided inside the electronic control system S, the log analysis device 20, 32 may perform communication with a device outside the vehicle, using an external communication ECU.

### (3) Details of Security Event Log

FIG. 5 is a diagram showing details of a security event log generated by the security sensor of the ECU, which is included in the electronic control system S.

The security event log includes, as fields, an ECU ID indicating identification information of the ECU to which the security sensor is equipped, a sensor ID indicating identification information of the security sensor, an event ID indicating identification information of a security event, a counter indicating occurrence number of the events, timestamp indicating occurrence time of the event, and context data indicating details of an output of the security sensor. The security event log may also have a header including information indicating a protocol version and a state of each field.

According to a specification defined by AUTOSAR (AUTomotive Open System ARchitecture), IdsM Instance ID corresponds to the ECU ID, Sensor Instance ID corresponds to the sensor ID, Event Definition ID corresponds to the event ID, Count corresponds to the counter, Timestamp corresponds to the timestamp, Context Data corresponds to the context data, Protocol Version or Protocol Header correspond to the header, respectively.

FIG. 5 is an example of an abnormality log indicating an abnormality. A normal log may also have the same configuration as the abnormality log shown in FIG. 5. In the normal log, the context data may be omitted. By setting a flag indicating a presence or absence of the context data in the header, it is possible to distinguish the abnormality log from the normal log by checking the flag.

FIG. 5 shows a security event log generated by a physically independent ECU. The security event log shown in FIG. 5 may be generated by a virtual ECU.

The security event log generated by the security sensor is referred to as SEv. A narrowed down and accurate security event log is referred to as QSEv. For example, the security sensor of the individual ECU in FIG. 4 generates SEv and reports it to an intrusion detection system manager (IdsM). When the SEv passes a certification filter and meets specified criteria in the IdsM, the SEv is transmitted as QSEv from the intrusion detection reporter to the outside of the vehicle. The security event log of the present embodiment is a concept that includes both SEv and QSEv.

In each embodiment described below, a case where the security log is generated by the security sensor illustrated in FIG. 4 will be described as an example. However, the security log in the present disclosure may be a log generated by a function of collecting and managing information related to an event that has occurred in the electronic control system, which is referred to as an in-vehicle SIEM (Security Information and Event Management).

(4) Relationship between Log Analysis Device and Attack Analysis Device

A device for analyzing a cyberattack on the electronic control system S corresponds to an attack analysis device. The attack analysis device acquires a security event log output from a security sensor of an ECU that constitutes the electronic control system S, and analyzes the type of cyberattack and the attack path of the cyberattack.

A security event log generated by detecting an abnormality in an ECU or network is not necessarily caused by a cyberattack. Here, a security event log that is not caused by a cyberattack is referred to as a false positive log. A case that is not due to a cyberattack is referred to as a false positive. The log analysis device of each embodiment determines whether the abnormality indicated by the security event log is false positive, and further determines whether there is a possibility that the abnormality indicated by the security event log is false positive, and reflects the determination result in the output.

The log analysis device of each embodiment having such functions may be included in the attack analysis device, or may be provided separately before the processing of the attack analysis device. The log analysis device may be implemented by a dedicated hardware device, or may be implemented by a general purpose hardware device and software.

### 2. First Embodiment

### (1) Configuration of Log Analysis Device

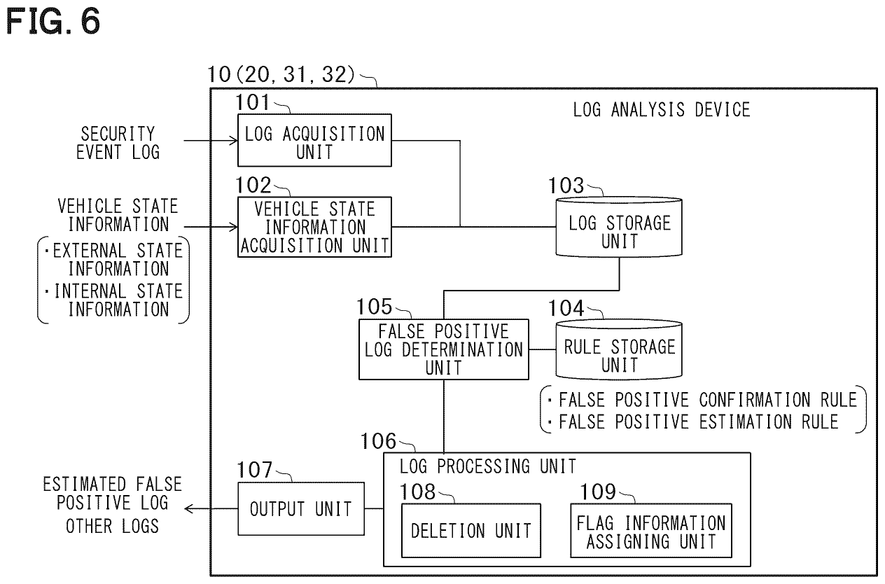

FIG. 6 is a block diagram showing a configuration of the log analysis device 10 according to the present embodiment. The log analysis device 10 includes a log acquisition unit 101, a vehicle state information acquisition unit 102, a log storage unit 103, a rule storage unit 104, a false positive log determination unit 105, a log processing unit 106, and an output unit 107. The log processing unit 106 includes a deletion unit 108 and a flag information assigning unit 109.

The log acquisition unit 101 acquires one or more security event logs indicating abnormalities detected by a security sensor of an ECU mounted on a vehicle. In the present embodiment, the log acquisition unit 101 is included in the log analysis device 10 arranged outside the vehicle, and therefore the security event log acquired by the log acquisition unit 101 is, for example, QSEv.

The acquiring time of the security event log may be every time a security event log is generated. Alternatively, the security event logs may be accumulated in the electronic control system S within a certain period of time and the log acquisition unit 101 may collectively receive the accumulated security event logs from the electronic control system S.

The vehicle state information acquisition unit 102 acquires vehicle state information indicating at least one of an internal state or an external state of the vehicle. Information indicating the internal state of the vehicle among the vehicle state information is referred to as internal state information. Information indicating the external state of the vehicle among the vehicle state information is referred to as external state information. The vehicle state information acquired by the vehicle state information acquisition unit 102 is vehicle state information at the time when an abnormality occurs. Here, the term “at the time when an abnormality occurs” indicates not only the time when the abnormality is occurred, but also the time close to the time when the abnormality is occurred, such as the time when the security event log indicating the abnormality is generated or the time when the security event log is received. Depending on the type of abnormality, the time span when the abnormality occurs may be properly set to a wide range.

There are various methods for acquiring vehicle state information when an abnormality is occurred. For example, the vehicle state information acquisition unit 102 may read the timestamp of the security event log and request, to the ECUs or sensors of the electronic control system S, the vehicle state information generated at the same as the time indicated by the timestamp or generated at the time close to the time indicated by the timestamp. In this way, the vehicle state information acquisition unit 102 may acquire the vehicle state information. Alternatively, the vehicle state information can be acquired by continuously acquiring and storing the vehicle state information in the log storage unit 103 and reading out the vehicle state information generated at the same time as or close to the time indicated by the timestamp. Instead of the time indicated by the timestamp, the time of transmission or reception of the security event log may be used as the time when an abnormality is occurred.

The external state information is information provided from sources other than the vehicle, or information about the external environment of the vehicle. Specific examples of external state information include information regarding a location of a vehicle factory or a vehicle testing center, a time at a vehicle factory or a vehicle testing center, a vehicle that has undergone measures at a vehicle factory or a vehicle testing center, communication failures on servers, an operating status of external device that provides services, weather and temperature, etc. The external state information can be acquired, for example, by receiving the information from the external device 40 that provides the external state information. Acquisition of the external state information may be triggered by a request from the log analysis device 10, or may be periodically distributed by the external device 40.

The internal state information is information relating to a behavior or state of the vehicle or a behavior or state of a component that constitute the vehicle. Specific examples of internal state information include vehicle location, vehicle type (VIN), vehicle speed, shift position, number of occupants, battery charge status, vehicle power status (IG-ON, IG-OFF, etc.), communication network status (Run, Ready, Stop, etc.), ECU status (ON, Sleep, OFF, etc.), and vehicle diagnostic status. These types of information can be acquired, for example, by receiving information output from various sensors of the vehicle.

The vehicle state information may also include the time at which the internal state or external state occurred, or a duration for which the internal state or external state continued. The term “time” may indicate a predetermined time point on the time axis, and includes time in a narrow sense, as well as a case where time is indirectly indicated, such as a timer, a clock, or the like. The “period of time” may be anything that indicates a length of time, and in addition to the narrow sense of period of time, it also includes cases where length of time is indirectly indicated, such as the time points of a start point and an end point, a timer, the number of clocks, cycles, or the like.

The log storage unit 103 stores the security event log acquired by the log acquisition unit 101 and the vehicle state information acquired by the vehicle state information acquisition unit 102.

The log storage unit 103 may be either a volatile memory such as a RAM, or a non-volatile memory such as a flash memory or a hard disk. The same applies to the rule storage unit 104 described below.

The rule storage unit 104 (corresponding to a “storage unit”) stores at least two types of rules used by the false positive log determination unit 105 described below. In the present embodiment, the rule storage unit 104 stores a false positive confirmation rule, which is used to determine whether an abnormality indicated by a security event log is false positive that is an abnormality not caused by a cyberattack, and a false positive estimation rule, which is used to determine whether an abnormality indicated by a security event log has a possibility of false positive. In the present embodiment, one or more false positive confirmation rules and one or more false positive estimation rules may be set for one occurrence reason of an abnormality.

The false positive confirmation rule lists cases in each of which a security event log can be confirmed as a definitive false positive log. For example, there may be a rule that definitively determines the flow from a cause to the occurrence of result, or a rule that has been adopted by a Security Operation Center (SOC) to determine the false positive log in the past. Alternatively, it may be the sum (or) or product (and) of the above-described rules.

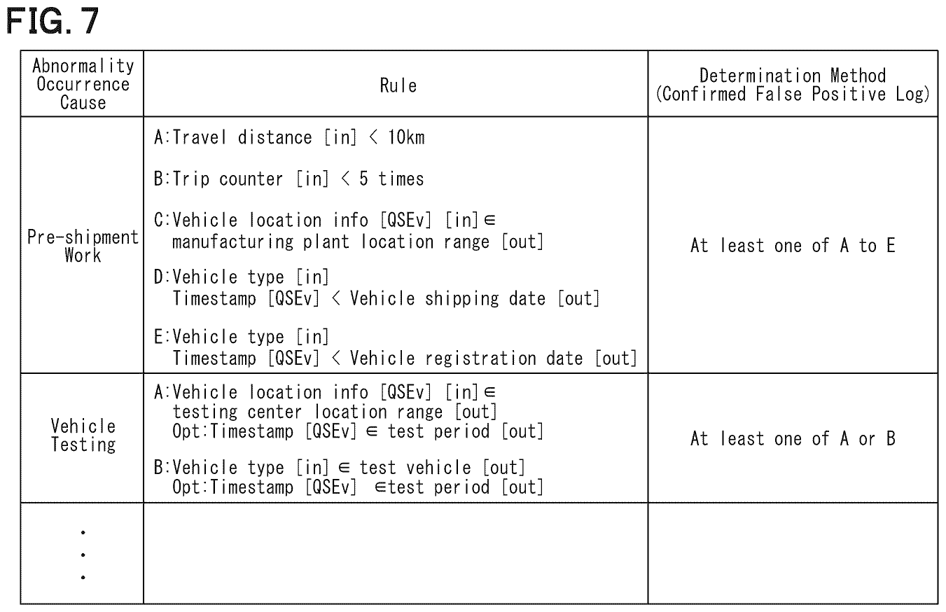

A specific example of the false positive confirmation rule will be described with reference to FIG. 7. FIG. 7 shows an example of false positive confirmation rule that indicates a relationship between a rule determined for each cause of abnormality and a determination method.

The following will describe a case where an abnormality occurs due to pre-shipment work, as shown in upper portion of FIG. 7.

For example, before a vehicle is shipped, connections to the outside world are disabled, so remote cyberattacks cannot occur in this stage. Therefore, a pre- shipment state of the vehicle can be determined from the security event log and the vehicle state information, it can be confirmed that the security event log indicating an abnormality that occurred before shipment of the vehicle is a false positive.

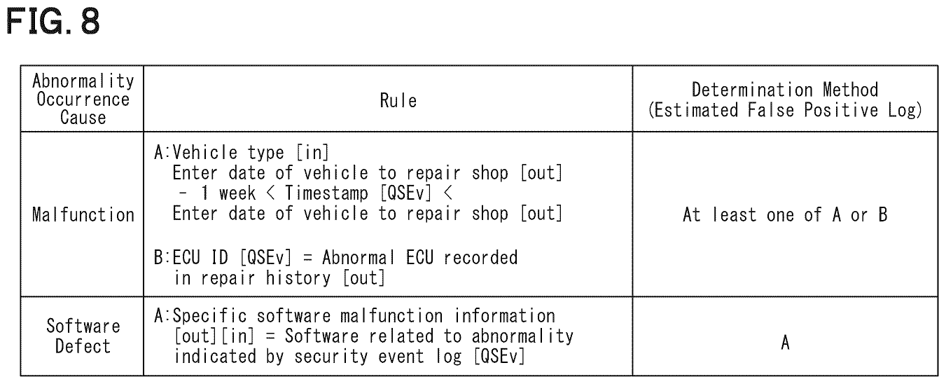

In FIG. 7, five rules are defined as rules for confirming the pre-shipment state of the vehicle. In FIG. 7, [in] presented in the rule indicates the internal state information, [out] presented in the rule indicates the external state information, and [QSEv] presented in the rule indicates information included in a security event log indicating an abnormality. The same applies to the rules shown in FIG. 8.

Rule A specifies that a travels distance of the vehicle is less than 10 km. When the travel distance of vehicle is within a typical distance before a delivery to the customer, it can be determined that the vehicle has not yet been delivered to the customer and has not yet been shipped.

Rule B specifies a trip counter is less than five times. This is because when the trip counter is within a typical value before a delivery to the customer, it can be determined that the vehicle has not yet been delivered to the customer and has not yet been shipped.

Rule C specifies that the vehicle location is within a range of a manufacturing plant location. This is because when the vehicle is within the range of manufacturing plant location, it can be determined that the vehicle is still at the manufacturing plant and has not yet been shipped.

Rule D specifies the vehicle type and specifies the security event log timestamp is set prior to the vehicle's shipping date. When the timestamp is set earlier than the shipping date of the vehicle, it can be determined that the vehicle has not yet been shipped.

Rule E specifies the vehicle type and specifies the security event log timestamp is set prior to a registration date of the vehicle. When the timestamp is set earlier than the vehicle's registration date, it can be determined that the vehicle has not yet been shipped, since it cannot be driven on public roads before registration.

FIG. 7 defines a method for determining a confirmed false positive log. In this example, when at least one of the rules A to E, each of which is used to specify that the vehicle has not yet been shipped, is satisfied, then the security event log indicating an abnormality can be confirmed to be a false positive log. That is, the security event log indicating an abnormality can be determined as a confirmed false positive log. This is because all of the rules A to E can be used independently to confirm that the vehicle has not yet been shipped.

The following will describe a case where a vehicle test is the cause of the abnormality with reference to the lower portion of FIG. 7.

For example, during vehicle testing in a testing center, the vehicle may be manipulated to perform operations that are not executed in actual use, such as sending messages directly to a communication bus that has been modified for the test environment. The possibility of a remote cyberattack on a test vehicle is not zero. A test vehicle has few optional instruments or additional instruments, and thus is less likely to become a target of cyberattack. Further, since there is no actual user of the vehicle, who needs to be protected from the cyberattack, the test vehicle has a low priority for monitoring. Therefore, a security event log indicating an abnormality occurred in a vehicle in the testing center may be highly a false positive log, and can be confirmed as a false positive log.

In FIG. 7, two rules are defined as rules for confirming whether an abnormality is occurred in the testing center.

Rule A specifies that the vehicle location is within a range of the testing center. When the vehicle is within the range of the location of testing center, it can be determined that the abnormality is occurred in the testing center. As an optional rule, the rule specifies that the timestamp of security event log is included in the test period. When the timestamp of the security event log is included in the test period, there is a higher possibility that the security event log is related to the test executed in the testing center.

Rule B specifies that the vehicle type is included in the test vehicle. When the vehicle type is included in the test vehicle, it can be determined that the vehicle is a vehicle used in the testing center. As an optional rule, the rule specifies that the timestamp of security event log is included in the test period. When the timestamp of the security event log is included in the test period, there is a higher possibility that the security event log is related to the test executed in the testing center.

At least one of the rules A and B for determining the vehicle testing state is satisfied, a security event log indicating an abnormality can be confirmed as a false positive log. This is because each of the rules A and B can be used independently to confirm that an abnormality is occurred in the testing center.

The false positive estimation rule includes a list of cases in each of which there is a possibility that a security event log is determined as a false positive log. For example, there is a rule in which estimation is involved in the flow from the cause to the occurrence of result, and a rule that definitively determines the flow from the cause to the occurrence of result but has not been adopted by the SOC to determine the false positive log in the past. Alternatively, it may be the sum (or) or product (and) of the above-described rules.

The following will describe specific examples of the false positive estimation rule with reference to FIG. 8. FIG. 8 shows an example of false positive estimation rule that indicates a relationship between a rule determined for each cause of abnormality and a determination method.

First, a case in which an abnormality occurs due to a failure will be described with reference to FIG. 8.

For example, in a vehicle with an abnormal ECU or abnormal wiring, abnormal operation may result in a security event log indicating an abnormality. Therefore, when a causal relationship with a failure can be estimated, a security event log indicating an abnormality can be estimated as a false positive.

In the upper portion of FIG. 8, two rules are defined for estimating occurrence of abnormality.

Rule A specifies that the vehicle type and timestamp of security event log is within one week prior to a date when the vehicle entered a repair shop to the date when the vehicle entered the repair shop. This is because, within this period, there is a high possibility that the security event log indicating abnormality is related to an abnormality actually occurred in the vehicle.

Rule B specifies that the ECU ID in the security event log is the same as the abnormal ECU recorded in a repair history. When a security event log is generated by an ECU in which a malfunction is actually occurred, it is highly likely that the event is related to the malfunction.

FIG. 8 also defines a determination method of an estimated false positive log. In this example, when at least one of the rules A or B for estimating the occurrence of failure is satisfied, a security event log indicating an abnormality can be determined as an estimated false positive log. This is because each of rules A and B is a rule that can independently estimate a causal relationship with an abnormality.

When both rules A and B are satisfied, occurrence of an abnormality can be estimated with a higher possibility, and thus it may be determined as a confirmed false positive log when both of rules A and B are satisfied. In a case where multiple false positive estimation rules are set for one cause of an abnormality, a false positive confirmation rule may be determined when multiple rules, whose number is equal to or greater than a predetermined number, are simultaneously satisfied.

Here, “equal to or greater than” includes both the case where the predetermined number is included (≤) and the case where the predetermined number is not included (<).

The following will describe a case where the cause of abnormality is a software defect with reference to upper portion of FIG. 8.

A software defect may cause an error in the security event log. If the software related to the error in the security event log can be identified and a causal relationship with a software defect can be estimated, then the security event log indicating abnormality can be estimated as a false positive log.

In the lower portion of FIG. 8, one rule is defined as a rule for estimating occurrence of software defect.

Rule A specifies that information indicating a malfunction of a specific software matches a software related to an abnormality indicated by the security event log. When a security event log related to a specific software indicates an abnormality, it is highly likely that the security event log is related to the software that has a malfunction.

Information indicating a malfunction of specific software may be acquired as external state information from information published by an automobile manufacturer, or may be acquired as internal state information from a list of installed software or update information stored in the vehicle. From this information, a software ID of specific software, a version of the specific software, or a release date of the specific software can be acquired.

When the security event log includes the software ID, the software version, or the software release date, these records of information can be used as information about the specific software related to the malfunction.

When the rule A is satisfied, the security event log indicating abnormality can be determined as an estimated false positive log.

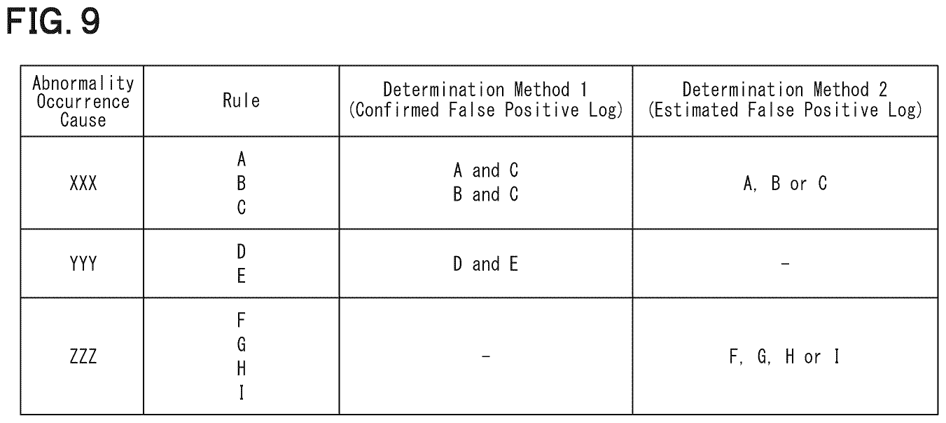

The false positive confirmation rules in FIG. 7 and the false positive estimation rules in FIG. 8 may be combined into one table. For example, as shown in FIG. 9, the table may include a column of method 1, which determines the confirmed false positive logs, and a column of method 2, which determines the estimated false positive logs, and the respective determination conditions may be added to the rules. In this case, like the abnormality occurrence cause XXX, there may be a case where the log is determined as a confirmed false positive log and a case where the log is determined as an estimated false positive log, depending on the combination of rules to be satisfied.

The false positive confirmation rules and the false positive estimation rules may be updated periodically or irregularly.

For example, when an analyst of SOC finds out a new rule while analyzing the security event logs, the rule may be updated each time or periodically.

When a machine processing is executable, the update can be executed automatically. For example, the vehicle state information acquisition unit 102 may acquire, as the external state information, information regarding the occurrence of communication malfunction, information regarding the server to be used, or information regarding the fact that repairing of vehicle is carried out, and the acquired external state information may be reflected in advance in the false positive confirmation rule or the false positive estimation rule.

For example, the time when a communication malfunction occurred or the time when the server to be used stops operation may be periodically distributed from the external device 40 or periodically request the external device 40 to distribute the information, and the acquired information may be applied, in advance, to the false positive confirmation rule or the false positive estimation rule.

Depending on the applying result of the information, a false positive estimation rule may be changed to a false positive confirmation rule, or conversely, a false positive confirmation rule may be changed to a false positive estimation rule.

For example, the external device 40 may store the applying history of false positive estimation rules. The log analysis device 10 periodically accesses the external device 40, and when there is a false positive estimation rule for which the number of security event logs estimated as a false positives is less than a predetermined number, for example less than one time, during a predetermined period after the rule was generated, the log analysis device 10 deletes the false positive estimation rule from the rule storage unit 104. When there is a false positive estimation rule that estimates security event logs, which have possibilities of false positive logs, as the estimated false positive logs and the number estimated security event logs is equal to or greater than a predetermined number, for example, 1000 or more, the false positive estimation rule stored in the rule storage unit 104 may be changed to a false positive confirmation rule.

The applying history may be a database in which the results indicating the log analysis device 10 automatically determining a log as an estimated false positive log are accumulated. Alternatively, the database may reflect results analyzed and verified by a human analyst for the results, which are automatically determined by the log analysis device 10 as the estimated false positive logs. With this configuration, the rules can be updated based on more accurate applying history, thereby improving an accuracy of determination of false positive logs.

When changing a false positive estimation rule to a false positive confirmation rule or deleting a false positive estimation rule, the false positive estimation rule itself may be changed or deleted, or the external state information and internal state information used in the false positive estimation rule may be changed or deleted together with the false positive estimation rule. According to this configuration, among the external state information and internal state information used in the rules, information that has a great number of applying history and high reliability can be used to configure the rules.

Returning to FIG. 6, the false positive log determination unit 105 determines whether the security event log acquired by the log acquisition unit 101 is a false positive or has a possibility of being a false positive. That is, based on at least one of the security event log or the vehicle state information, the false positive log determination unit determines whether the security event log is a confirmed false positive log, which is confirmed to be a false positive log, using the false positive confirmation rules, and further determines whether the security event log is an estimated false positive log, which has a possibility of false positive log, using the false positive estimation rules.

Here, “based on” includes cases where the security event log and/or vehicle state information is used directly, as well as cases where the security event log and/or vehicle state information is used indirectly. Indirect use of the security event log and/or vehicle state information includes cases where intermediate facts are estimated from security event logs and/or vehicle state information, and false positive determinations are made using the intermediate facts.

The false positive log determination unit 105 acquires information necessary for determining each rule based on the false positive confirmation rules shown in FIG. 7 and FIG. 9, each field of the security event log stored in the log storage unit 103, and the external state information and the internal state information stored in the log storage unit 103. Using these records of information, each rule is determined and whether the security even log acquired by the log acquisition unit 101 is the confirmed false positive log or not is determined using the determination method of false positive confirmation rule.

For the estimated false positive log, a similar determination is made using the false positive estimation rules shown in FIG. 8 and FIG. 9, thereby determining whether the security event log acquired by the log acquisition unit 101 is an estimated false positive log.

The false positive log determination unit 105 may perform determination by using the false positive confirmation rules first, and then perform determination by using the false positive estimation rules. First, it is determined whether a security event log is a confirmed false positive log, and then it is determined whether a remaining security event log excluding the security event log has been determined to be the confirmed false positive log is an estimated false positive log. For example, suppose that the rule having a cause XXX of abnormality occurrence shown in FIG. 9 is executed. The false positive log determination unit 105 first determines whether the rules A and C are satisfied or not. When both rules A and C are satisfied it is determined that determination method 1 is satisfied, and therefore determination method 2 is not executed. The false positive log determination unit 105 may determine whether the rules A, B, and C are satisfied or not. When only the rule B is satisfied, the determination method 1 is not satisfied and the determination method 2 is executed.

When narrowing down the false positive confirmation rules and the false positive estimation rules, a filter may be used to narrow down the rules. For example, vehicle type (VIN), vehicle location, and time may be used in the rules. Thus, by using these records of information in the filtering, it is possible to efficiently narrow down the applicable rules.

The log processing unit 106 processes the security event log based on the determination result of the false positive log determination unit 105. In the present embodiment, a security event log determined as a confirmed false positive log is deleted by the deletion unit 108 of the log processing unit 106. The flag information assigning unit 109 of the log processing unit 106 assigns flag information to a security event log, which is determined as the estimated false positive log.

The flag information indicates that the log is an estimated false positive log. The flag information may be assigned externally to the estimated false positive log, or may be included in the estimated false positive log. When the flag information is included in the estimated false positive log, it may be included in the header or context data area shown in FIG. 4.

The flag information may include information indicating a level of possibility that the log is an estimated false positive log. For example, when the cause of abnormality is ZZZ as shown in FIG. 9, the flag information may include a value indicating the number of rules F, G, H, and I that are satisfied. For example, the flag information may include a numerical value such as 1 or 25% when one rule out of four rules is satisfied, and 3 or 75% when three out of four rules are satisfied.

The deletion unit 108 may generate deletion information indicating that a security event log determined as a confirmed false positive log is deleted, and output the deletion information to the output unit 107. The deletion information may include information that can identify the deleted security event log.

The output unit 107 outputs the processing result of the log processing unit 106. The confirmed false positive log is not output. The estimated false positive log is output together with the flag information indicating the estimated false positive. The output unit 107 also outputs other security event logs that are not determined to be the confirmed false positive logs or the estimated false positive logs. The output unit 107 may output the deletion information, which is output from the deletion unit 108. The output destination of the output unit 107 is, for example, an external server that manages the SOC.

Here, “together with” includes a case where the flag information is added to the outside of the estimated false positive log and a case where the flag information is included inside the estimated false positive log.

### (2) Operation of Log Analysis Device

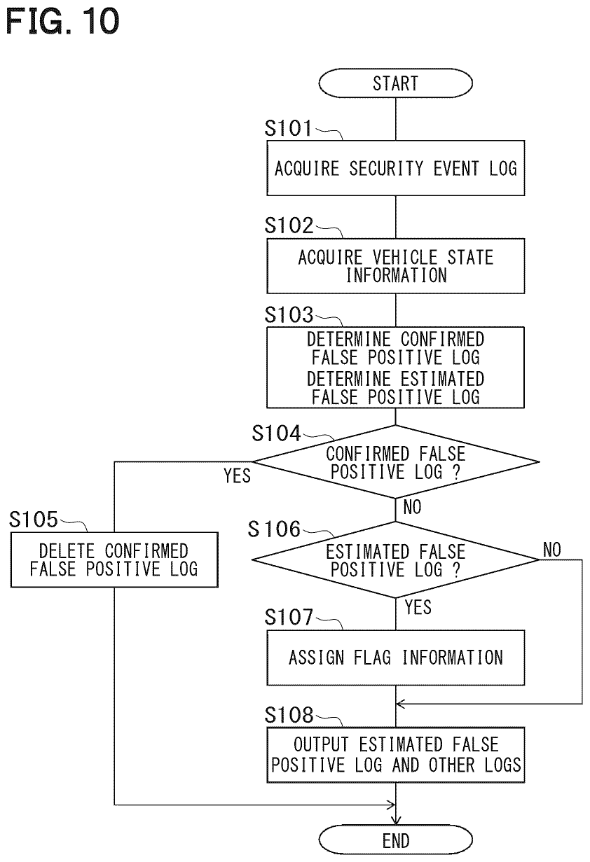

The following will describe an operation of the log analysis device 10 with reference to FIG. 10. FIG. 10 shows not only the log analysis method executed by the log analysis device 10, but also the processing procedure of the log analysis program executed by the log analysis device 10. The order of the process procedure is not limited to the specific order shown in FIG. 10. For example, the order may be interchanged unless there are restrictions, such as a relationship in which one step uses a result of previous step.

In S101, the log acquisition unit 101 acquires one or more security event logs, each of which indicates an abnormality detected by a security sensor of an electronic control unit mounted on a vehicle.

In S102, the vehicle state information acquisition unit 102 acquires the vehicle state information indicating the internal state and/or the external state of the vehicle.

In S103, the false positive log determination unit 105 determines, based on the security event log and/or the vehicle state information, whether the security event log is a confirmed false positive log, which is confirmed as a false positive log, using a false positive confirmation rule. The false positive log determination unit 105 further determines, based on the security event log and/or the vehicle state information, whether the security event log is an estimated false positive log, which has a possibility of being a false positive log, using a false positive estimation rule.

In S104, when the security event log is determined, in S103, as a confirmed false positive log (S104: Y), the deletion unit 108 of the log processing unit 106 deletes the confirmed false positive log in S105. When the security event log is not determined, in S103, as a confirmed false positive log (S104: N), the process proceeds to S106.

When the security event log is determined, in S103, as an estimated false positive log (S106: Y), the flag information assigning unit 109 of the log processing unit 106 assigns the flag information to the estimated false positive log in S107, and the process proceeds to S108. When the security event log is not determined, in S103, as an estimated false positive log (S106: N), the process proceeds to S108.

In S108, the output unit 107 does not output the confirmed false positive log that is deleted in S105, but outputs the estimated false positive log to which the flag information is assigned in S107 and other logs.

### (3) Overview

As described above, according to the log analysis device 10 of the present embodiment, a determination is carried out using the false positive confirmation rules and the false positive estimation rules, so that only security event logs that are determined as confirmed false positive logs are deleted, and security event logs that are determined as estimated false positive logs can be output to a subsequent step without being deleted. As a result, a risk of deleting important security event logs can be suppressed.

According to the log analysis device 10 of the present embodiment, a security event log, which has a possibility of false positive log, is output with assigned flag information, so that a determination can be made in a later step with consideration of a possibility of false positive log.

According to the log analysis device 10 of the present embodiment, multiple rules are set for one cause of an abnormality, thereby restricting the possibility of detection failure of false positive or a possible false positive even when the cause of the abnormality actually exists. In the present embodiment, since a log that simultaneously satisfies at least a predetermined number of rules is determined as a confirmed false positive log, a log that satisfies less than the predetermined number of rules is determined as an estimated false positive log. Thus, the criteria for determination can be made clear.

According to the log analysis device 10 of the present embodiment, determination is first carried out using the false positive confirmation rules, and then determination is carried out using the false positive estimation rules for the remaining security event logs excluding the security event logs determined as the confirmed false positive logs, thereby reducing the number of determination targets to be determined. As a result, the processing burden of the log analysis device 10 can be reduced.

### 3. Second Embodiment

The log analysis device 10 of the first embodiment is provided outside the vehicle as shown in FIG. 1. The log analysis device 20 of the second embodiment differs from the log analysis device 10 of the first embodiment in that the log analysis device 20 of the second embodiment is mounted on a vehicle as shown in FIG. 2. Since the configuration of log analysis device 20 in the present embodiment is basically the same as the configuration of log analysis device 10 in the first embodiment, details of configuration and operation of the log analysis device 20 will be omitted.

In the present embodiment, the log acquisition unit 101 is connected to the electronic control system S, and therefore the security event log acquired by the log acquisition unit 101 is, for example, SEv or QSEv.

### 4. Third Embodiment

In the present embodiment, a log analysis device 31 is provided outside the vehicle and a log analysis device 32 is provided inside the vehicle. The configurations of the log analysis devices 31, 32 of the present embodiment are the same as the configurations of the log analysis device 10 of the first embodiment and the log analysis device 20 of the second embodiment, as shown in FIG. 6. Thus, details of configuration and operation of the log analysis devices 1, 32 will be omitted.

The log analysis device 31 and the log analysis device 32 of the present embodiment are assigned with the functions of the log analysis device 10 described in the first embodiment. Examples of function allocation will be described below.

### Example 1

### (Allocation Based on Acquired Vehicle State Information)

As described above, when the log analysis device is provided inside the vehicle, the log analysis device is suitable for acquiring the internal state information. Therefore, in the present embodiment, the vehicle state information acquisition unit 102 of the log analysis device 32 may acquire only the internal state information from the vehicle state information. In this case, the rule storage unit 104 of the log analysis device 32 stores false positive confirmation rules and false positive estimation rules, which use only the internal state information and information included in the security event log.

The vehicle state information acquisition unit 102 of the log analysis device 31 may acquire only the external state information from the vehicle state information. Then, the rule storage unit 104 of the log analysis device 31 stores false positive confirmation rules and false positive estimation rules, which use only the external state information and information included in the security event log.

Some of the false positive confirmation rules and the false positive estimation rules require both of the internal state information and the external state information. In this case, the rules may be stored in the rule storage unit 104 of either the log analysis device 31 or the log analysis device 32. When the rules are stored in the log analysis device 31, the internal state information required for the determination may be received from the vehicle. When the rules are stored in the log analysis device 32, the external state information required for the determination may be received from the external device 40 or the like.

According to the above-described allocation, it is possible to perform a determination using the vehicle state information that is easily acquired depending on the location where the log analysis device is arranged.

### Example 2

### (Allocation Based on False Positive Confirmation Rules and False Positive Estimation Rules)

The rule storage unit 104 of the log analysis device 10 of the first embodiment and the rule storage unit 104 of the log analysis device 20 of the second embodiment store both of the false positive confirmation rules and the false positive estimation rules, and the false positive log determination unit 105 determines the security even log using the false positive confirmation rules and the false positive estimation rules. In the present embodiment, either the false positive confirmation rules or the false positive estimation rules are allocated to the log analysis device 31 and the other are allocated to the log analysis device 32.

When the false positive estimation rules are allocated to the log analysis device 31 (corresponding to a first log analysis device) arranged outside the vehicle, and false positive confirmation rules are allocated to the log analysis device 32 (corresponding to a second log analysis device) arranged inside the vehicle, the confirmed false positive logs are deleted on the vehicle side, so that the vehicle side does not need to send all security event logs. As a result, the communication traffic can be reduced. The false positive estimation rules, which require a relatively large amount of calculation, can be performed by a device outside the vehicle that has high processing resource capability.

A part of the multiple false positive confirmation rules may be allocated to the log analysis device 32 arranged inside the vehicle, and determination may be carried out using those false positive confirmation rules. The remaining false positive confirmation rules may be allocated to the log analysis device 31 arranged outside the vehicle, and determination may be carried out using those false positive confirmation rules. In this case, the allocation of the false positive estimation rules may be appropriately set. In this example, since the confirmed false positive log is deleted on the vehicle side, the vehicle side does not need to transmit all of the security event logs. As a result, the communication traffic can be reduced. The false positive confirmation rules allocated to the log analysis device 32, which is arranged inside the vehicle, may be redundantly allocated to the log analysis device 31, which is arranged outside the vehicle. In this configuration, determination using the false positive confirmation rules may be performed both on the vehicle side and an outside device. According to this configuration, in addition to being able to reduce communication traffic by using a mechanism for deleting the confirmed false positive logs on the vehicle side, by redundantly providing a mechanism for deleting the confirmed false positive logs outside the vehicle, it is possible to more reliably delete the confirmed false positive logs.

When the false positive confirmation rules are allocated to the log analysis device 32, which is arranged inside the vehicle, the allocated false positive confirmation rules may be rules that use only the internal state information and information included in the security event log, as described in the Example 1. This configuration can reduce an amount of communication traffic by using a mechanism for deleting the confirmed false positive logs on the vehicle side, and can also achieve the technical effect of Example 1, that is, the vehicle side can make determination using the vehicle state information that is easy to be acquired on the vehicle side.

When the false positive confirmation rules are allocated to the log analysis device 31 (corresponding to a first log analysis device) arranged outside the vehicle and the false positive estimation rules are allocated to the log analysis device 32 (corresponding to a second log analysis device) arranged inside the vehicle, the important process of deleting security event logs can be performed all at once by a device arranged outside the vehicle.

The false positive confirmation rules and a part of the false positive estimation rules may be allocated to the log analysis device 31, which is arranged outside the vehicle. The remaining part of the false positive estimation rules may be allocated to the log analysis device 32, which is arranged inside the vehicle. Similar to the Example 1, a part of the false positive estimation rules allocated to the log analysis device 32, which is arranged inside the vehicle, may be false positive confirmation rules that include rules using only the internal state information and the information included in the security event log. The false positive estimation rules may be redundantly allocated to both of the on-board log analysis device and an external log analysis device. With this configuration, the important process of deleting the security event log can be performed all at once by a device outside the vehicle.

### 5. Conclusions

The features of the log analysis device or the like in each embodiment of the present disclosure have been described.

Since the terms used in each embodiment are examples, these terms may be replaced with terms that are synonymous or include synonymous functions.

The block diagram used for the description of each embodiment is obtained by classifying and arranging the configuration of the device by function. The blocks representing the respective functions may be implemented by any combination of hardware or software. Further, since the blocks show the function, the block diagram can be understood as a disclosure of the method and a disclosure of the program to implement the method.

The order of the functional blocks that can be understood as the processing, the flow, and the method described in each embodiment may be changed unless there are restrictions, such as a relationship in which one step uses the result of another step in the preceding step.

The terms such as first, second, to N-th (where N is an integer) used in each embodiment and in the present disclosure are used to distinguish two or more configurations and methods of the same kind and are not intended to limit the order or superiority.

Further, examples of the form of the log analysis device of the present disclosure include the following. Examples of a form of a component include a semiconductor device, an electronic circuit, a module, and a microcomputer. Examples of a form of a semi-finished product include an electric control unit (ECU) and a system board. Examples of a form of a finished product include a cellular phone, a smartphone, a tablet computer, a personal computer (PC), a workstation, and a server. Other examples may include devices having communication functions, such as a video camera, a still camera, or a car navigation system.

Necessary functions such as an antenna or a communication interface may be appropriately added to the log analysis device.

It is assumed that the log analysis device of the present disclosure will be used for the purpose of providing various services, especially when used on the server side. Upon providing the service, the log analysis device of the present disclosure will be used, the method of the present disclosure will be used, or/and the program of the present disclosure will be executed.

The device can be implemented not only by dedicated hardware having the configurations and functions described in the embodiments, but also by a combination of a program, which is recorded on a storage medium such as a memory or a hard disk and is used for implementing the above configuration and features, and general-purpose hardware that has a dedicated or general-purpose CPU that can execute the program, a memory, and the like.

A program stored in a non-transitory tangible storage medium (for example, an external storage device (a hard disk, a USB memory, and a CD/BD) of dedicated or general-purpose hardware, or an internal storage device (a RAM, a ROM, and the like)) may also be provided to dedicated or general-purpose hardware via the storage medium or from a server via a communication line without using the storage medium. As a result, it is possible to always provide the latest functions through program upgrade.

The log analysis device may be used to analyze security event logs generated by a security sensor of electronic control system installed in an object other than the vehicle.

1. A log analysis device comprising:
a log acquisition unit acquiring one or more security event logs indicating abnormalities detected by a security sensor of an electronic control device mounted on a vehicle;
a vehicle state information acquisition unit acquiring vehicle state information indicating an internal state or an external state of the vehicle;
a storage unit storing a false positive confirmation rule and a false positive estimation rule, wherein the false positive confirmation rule is used to determine whether the abnormalities indicated by the one or more security event logs are false positive abnormalities that are not caused by a cyberattack, and the false positive estimation rule is used to determine whether the abnormalities indicated by the one or more security event logs have possibilities of false positive abnormalities;
a false positive log determination unit determining, based on the one or more security event logs or the vehicle state information, whether each of the one or more security event logs is a confirmed false positive log, which is confirmed as a false positive log, using the false positive confirmation rule, the false positive log determination unit further determining, based on the one or more security event logs or the vehicle state information, whether each of the one or more security event logs is an estimated false positive log, which has a possibility of false positive log, using the false positive estimation rule; and
an output unit controlling the confirmed false positive log not to be output while outputting the estimated false positive log together with flag information indicating that the security event log being determined as the estimated false positive log.

2. The log analysis device according to claim 1, wherein
the false positive confirmation rule refers to a rule in which a flow from a cause of abnormality to a result of abnormality is definitively determined, and
the false positive estimation rule refers to a rule in which an estimation is involved in the flow from the cause of abnormality to the result of abnormality.

3. The log analysis device according to claim 1, wherein
the false positive confirmation rule is a rule that has a determination history by a security operation center (SOC) as the false positive log, and
the false positive estimation rule is a rule that has no determination history by the SOC as the false positive log.

4. The log analysis device according to claim 1, wherein,
in each of the false positive confirmation rule and the false positive estimation rule, one or more rule items are set for one cause of abnormality occurrence.

5. The log analysis device according to claim 4, wherein,
in the false positive estimation rule, when (i) more than one rule items are set for one cause of abnormality occurrence and (ii) at least a predetermined number of the rule items out of all of the rule items are simultaneously satisfied, the false positive estimation rule is determined to be satisfied.

6. The log analysis device according to claim 1, wherein
the false positive confirmation rule and the false positive estimation rule are updated periodically or irregularly.

7. The log analysis device according to claim 1, wherein
the false positive log determination unit first determines whether each of the one or more security event logs is the confirmed false positive log, and then determines whether each of remaining security event logs excluding the security event log determined as the confirmed false positive log is the estimated false positive log.

8. The log analysis device according to claim 1, wherein
the flag information includes information indicating a level of possibility that the security event log is the estimated false positive log.

9. The log analysis device according to claim 1, wherein
the log analysis device is arranged outside the vehicle.

10. The log analysis device according to claim 9, wherein
the vehicle state information acquisition unit acquires, as the vehicle state information, external state information indicating an external state related to the vehicle.

11. The log analysis device according to claim 1, wherein
the log analysis device is mounted on the vehicle.

12. The log analysis device according to claim 11, wherein
the vehicle state information acquisition unit acquires, as the vehicle state information, internal state information indicating an internal state related to the vehicle.

13. The log analysis device according to claim 1, wherein
a part of the log analysis device is arranged, as a first log analysis device, in the vehicle and remaining part of the log analysis device is arranged, as a second log analysis device, outside the vehicle.

14. A log analysis method performed by at least one processor included in a log analysis device by executing a computer program stored in a non-transitory tangible storage medium, wherein the log analysis device includes a storage unit storing a false positive confirmation rule and a false positive estimation rule, the false positive confirmation rule is used to determine whether an abnormality indicated by a security event log is a false positive abnormality that is not caused by a cyberattack, and the false positive estimation rule is used to determine whether the abnormality indicated by the security event log has a possibility of the false positive abnormality,
the log analysis method comprising:
acquiring one or more security event logs indicating abnormalities detected by a security sensor of an electronic control device mounted on a vehicle;
acquiring vehicle state information indicating an internal state or an external state of the vehicle;
based on the one or more security event logs or the vehicle state information, determining whether each of the one or more security event logs is a confirmed false positive log, which is confirmed as a false positive log, using the false positive confirmation rule and determining whether each of the one or more security event logs is an estimated false positive log, which has a possibility of false positive log, using the false positive estimation rule; and
outputting the estimated false positive log together with flag information, which indicates that the security event log being determined as the estimated false positive log, with the confirmed false positive log being not output.

15. A non-transitory tangible storage medium storing a log analysis program to be executed by at least one processor of a log analysis device, wherein the log analysis device includes a storage unit storing a false positive confirmation rule and a false positive estimation rule, the false positive confirmation rule is used to determine whether an abnormality indicated by a security event log is a false positive abnormality that is not caused by a cyberattack, and the false positive estimation rule is used to determine whether the abnormality indicated by the security event log has a possibility of the false positive abnormality,
the log analysis program comprising instructions, when executed by the at least one processor, configured to:
acquire one or more security event logs indicating abnormalities detected by a security sensor of an electronic control device mounted on a vehicle;
acquire vehicle state information indicating an internal state or an external state of the vehicle;
based on the one or more security event logs or the vehicle state information, determine whether each of the one or more security event logs is a confirmed false positive log, which is confirmed as a false positive log, using the false positive confirmation rule and determine whether each of the one or more security event logs is an estimated false positive log, which has a possibility of false positive log, using the false positive estimation rule; and
output the estimated false positive log together with flag information, which indicates that the security event log being determined as the estimated false positive log, with the confirmed false positive log being not output.

16. A log analysis device comprising:
a processor and a memory storing a program that causes the processor to perform:
acquiring one or more security event logs indicating abnormalities detected by a security sensor of an electronic control device mounted on a vehicle;
acquiring vehicle state information indicating an internal state or an external state of the vehicle;
acquiring a false positive confirmation rule and a false positive estimation rule from a storage unit storing the false positive confirmation rule and the false positive estimation rule, wherein the false positive confirmation rule is used to determine whether the abnormalities indicated by the one or more security event logs are false positive abnormalities that are not caused by a cyberattack, and the false positive estimation rule is used to determine whether the abnormalities indicated by the one or more security event logs have possibilities of false positive abnormalities; and
determining, based on the one or more security event logs or the vehicle state information, whether each of the one or more security event logs is a confirmed false positive log, which is confirmed as a false positive log, using the false positive confirmation rule, and further determining, based on the one or more security event logs or the vehicle state information, whether each of the one or more security event logs is an estimated false positive log, which has a possibility of false positive log, using the false positive estimation rule.

17. The log analysis device according to claim 16, wherein
the program stored in the memory further causes the processor to perform:
outputting information indicating, from among the one or more security event logs, a security event log determined as the estimated false positive log.

18. A non-transitory tangible computer-readable storage medium storing a program, when executed by a computer, to cause the computer to perform:
acquiring one or more security event logs indicating abnormalities detected by a security sensor of an electronic control device mounted on a vehicle;
acquiring vehicle state information indicating an internal state or an external state of the vehicle;
acquiring a false positive confirmation rule and a false positive estimation rule from a storage unit storing the false positive confirmation rule and the false positive estimation rule, wherein the false positive confirmation rule is used to determine whether the abnormalities indicated by the one or more security event logs are false positive abnormalities that are not caused by a cyberattack, and the false positive estimation rule is used to determine whether the abnormalities indicated by the one or more security event logs have possibilities of false positive abnormalities; and
determining, based on the one or more security event logs or the vehicle state information, whether each of the one or more security event logs is a confirmed false positive log, which is confirmed as a false positive log, using the false positive confirmation rule, and further determining, based on the one or more security event logs or the vehicle state information, whether each of the one or more security event logs is an estimated false positive log, which has a possibility of false positive log, using the false positive estimation rule.

19. A system comprising:
a vehicle; and
a log analysis device placed outside the vehicle,
wherein the vehicle includes a plurality of electronic control devices connected via a network in the vehicle, each electronic control device includes one or more security sensors each configured to detect an abnormality,
wherein the log analysis device includes a processor and a memory storing a program that causes the processor to perform:
acquiring one or more security event logs indicating abnormalities detected by the security sensor of the electronic control device mounted on the vehicle;
acquiring vehicle state information indicating an internal state or an external state of the vehicle;
acquiring a false positive confirmation rule and a false positive estimation rule from a storage unit storing the false positive confirmation rule and the false positive estimation rule, wherein the false positive confirmation rule is used to determine whether the abnormalities indicated by the one or more security event logs are false positive abnormalities that are not caused by a cyberattack, and the false positive estimation rule is used to determine whether the abnormalities indicated by the one or more security event logs have possibilities of false positive abnormalities; and
determining, based on the one or more security event logs or the vehicle state information, whether each of the one or more security event logs is a confirmed false positive log, which is confirmed as a false positive log, using the false positive confirmation rule, and further determining, based on the one or more security event logs or the vehicle state information, whether each of the one or more security event logs is an estimated false positive log, which has a possibility of false positive log, using the false positive estimation rule.
